(19) United States
(12) Patent Application Publication
(10) Pub. No.: US 2009/0031142 A1
(43) Pub. Date: Jan. 29, 2009

(54) System, Method and Computer Program Product for Processing a Memory Page

(76) Inventors: Shai Halevi, Elmsford, NY (US); William Eric Hall, Clinton, CT (US); Hugo Mario Krawczyk, Tarrytown, NY (US); Julian Satran, Atlit (IL); Ilan Shimony, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 11/782,646

(22) Filed: Jul. 25, 2007

(51) Int. Cl. H04L 9/00

(52) U.S. Cl. 713/190

(57) ABSTRACT

A method for processing a memory page, the method includes: retrieving, in response to a request to provide a first memory page to a processor, first memory page metadata associated with first memory page address information; wherein the first memory page address information is stored in a memory page table; and performing a page operation in response to the memory page metadata; wherein the page operation is selected from a group consisting of compression, cryptography, searching a page for a virus signature, searching a page for digital right management signature, error correction code verification, error correction code addition.

### FIELD OF THE INVENTION

The present invention relates to methods, systems and computer program products for processing a memory page.

### BACKGROUND OF THE INVENTION

Due to cost, speed and/or size constraints information (including data and/or instructions) is spread among one or more internal memory units and one or more external memory units and/or external storage medium. The information can be exchanged between one memory unit to another. The exchange of information between memory units and/or processing units, as well as the storage of the information should be secure, thus cryptographic operations should be applied.

Different computerized systems can be characterized by different cryptographic configurations. Accordingly, while some computerized systems perform cryptographic operations by hardware cryptographic entities, other computerized systems perform these operations by software cryptographic entities, yet further computerized systems perform cryptographic operations by a combination of hardware and software cryptographic entities. In addition, cryptographic entities can be located in (or processed by processors that are located in) different locations. For example, a cryptographic entity can be software executed by a processor, can be located in a memory controller hub (also referred to as the Northbridge), within a remote disk controller, within the Southbridge, and the like.

Applications that control the exchange of information must be modified in response to cryptographic configurations so as to facilitate the cryptographic operations. These modifications can be complex and time consuming.

There is a need to provide an efficient system, method and computer program product that will enable the cryptographic processing of memory pages.

### SUMMARY OF THE PRESENT INVENTION

A method for processing a memory page, the method includes: retrieving, in response to a request to provide a first memory page to a processor, first memory page metadata associated with first memory page address information; wherein the first memory page address information is stored in a memory page table; and performing a page operation in response to the memory page metadata; wherein the page operation is selected from a group consisting of compression, cryptography, searching a page for a virus signature, searching a page for digital right management signature, error correction code verification, error correction code addition.

### BRIEF DESCRIPTION OF THE DRAWINGS

The present invention will be understood and appreciated more fully from the following detailed description taken in conjunction with the drawings in which:

FIGS. 1-4 illustrate a retrieval of memory page metadata, according to various embodiments of the invention;

FIG. 5 illustrates various data structures according to an embodiment of the invention; and

FIG. 6 illustrated a method for processing a memory page, according to an embodiment of the invention.

### DETAILED DESCRIPTION OF THE DRAWINGS

Methods, systems and computer program products for processing a memory page are provided. For simplicity of explanation most of the following explanation will refer to performing cryptographic operations and to metadata that is cryptographic metadata. It is noted that the methods, systems and computer program products can be applied mutatis mutandis to other operations such as compression,

A cryptographic operation can be applied by a cryptographic entity after cryptographic entity receives memory page cryptography metadata. The memory page cryptography metadata can indicate which cryptographic operation to perform, when to perform a cryptographic operation, when to prevent from performing a cryptographic operation. Additionally or alternatively, the memory page cryptography metadata can include cryptographic parameters such as a decryption key, an encryption key and the like.

Additionally or alternatively, the memory page cryptographic metadata can store the cryptographic processing state, i.e. information such as the progress of the cryptography process and especially which portion of the memory page was already cryptographically processed.

Additionally or alternatively, the memory page cryptographic metadata can indicate whether to perform compression, indicate allowed users, can indicate which encryption algorithm to utilize

Additionally or alternatively, the memory page metadata can include a content based signature for ensuring the memory page authenticity and that it was not changed by a non-authorized user.

Depending upon the location of the memory entities that store the memory page cryptography metadata, this metadata can be retrieved by using virtual addresses, physical addresses, and the like. Memory page cryptography metadata provides page granularity. Once a memory page is requested by a processor the associated memory page cryptography metadata is sent to a processing entity. A processing entity that performs cryptographic entity.

According to an embodiment of the invention the memory page cryptography metadata is an extension to a page table that stores memory page access information.

The memory page cryptography metadata can be treated as a logical extension to the page table thus can be virtually invisible even to “privileged” parts of the programming environment. The memory page cryptography metadata can be made visible to either a specialized hardware component or a specialized virtual machine operating itself on either specialized hardware or not.

Using memory page cryptography metadata enables software to operate unchanged and cryptographic operation on data to be performed on separate components. Thus it can allow many applications to operate without change including those in which the application itself must be subject to check (such as a licensed piece of software).

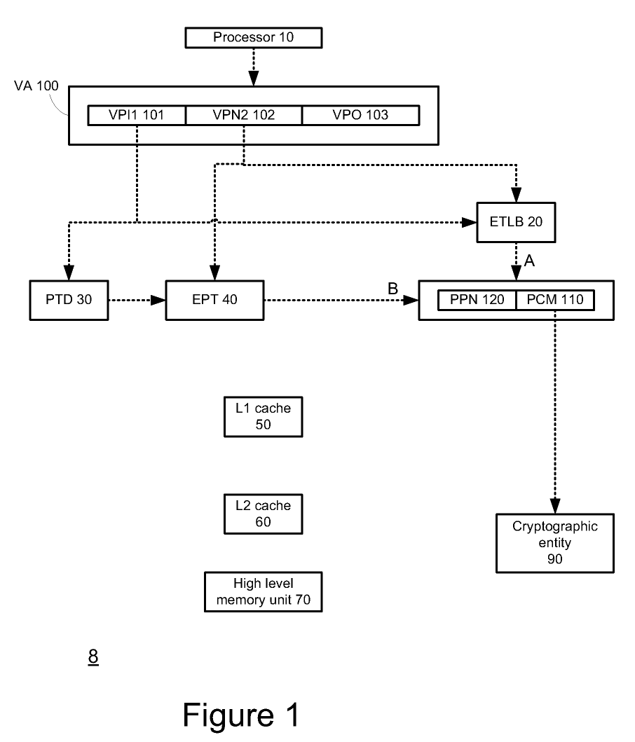

FIG. 1 illustrates a retrieval of memory page cryptography metadata (denoted PCM 110) from enhanced page table (EPT) 40 and a retrieval of PCM 110 from an enhanced translation look-aside buffer (ETLB) 20, according to various embodiments of the invention. It is noted that PCM 110 is usually retrieved from EPT 40 only if it is not stored in ETLB 20.

Processor 10 (or another entity controlled by or accessed by processor 10) may request a memory page by providing a virtual address (VA) 100. The virtual address includes multiple portions such as virtual page identity VPI1 101, virtual page number VPN2 102 and virtual page offset VPO 103.

Portions of VA 100 are sent to one or more retrieval paths. A first retrieval path includes ETLB 20. ETLB 20 stores memory page cryptography metadata and memory page address information. ETLB 20 is quite small and usually includes few entries. Each entry can store recently utilized memory page cryptography metadata and memory page address information. VPI1 101 and VPN2 102 are sent to ETLB 20 in order to retrieve the required memory page cryptography metadata and memory page address information.

If an ETLB 20 hit occurs (the hit is illustrated by letter A), then ETLB 20 sends memory page cryptography metadata (denoted PCM) associated with the memory page address information to cryptographic entity 90. ETLB 20 also sends memory page address information, such as physical page number (PPN) 120 and VPO 103 to a memory unit such as L1 cache 50. PPN 120 and VPO 103 form a physical address of the requested memory page. In virtualized environments PA can be a physical address or a pseudo-physical address which could be followed by an additional level of address translation controlled by a security or isolation hypervisor or reference monitor.

If ETLB 20 does not store the required memory page cryptography metadata then this metadata can be retrieved from other retrieval paths.

FIG. 1 also illustrates a second retrieval path that includes page table directory (PTD) 30 and enhanced page table (EPT) 40. It is noted that if an ETLB miss occurs and the memory page cryptography metadata and memory page address information are retrieved from another retrieval path then ETLB 20 is updated with the memory page cryptography metadata and memory page address information.

VPI1 101 is sent to PTD 30 and is used to select an enhanced page table such as EPT 40 out of multiple enhanced page tables (not shown).

An enhanced page table can be allocated per consumer or group (shared memory segments) and the identity of the consumer or group can be represented by VPI1 101. It is further noted that for simplicity of explanation only a single EPT is shown.

VPN2 102 is sent to EPT 40 and is used to select an entry of EPT 40. The selected entry can store PPN 120 and PCM 110. Letter B illustrates the provision of PPN 120 and PCM 110 from EPT 40.

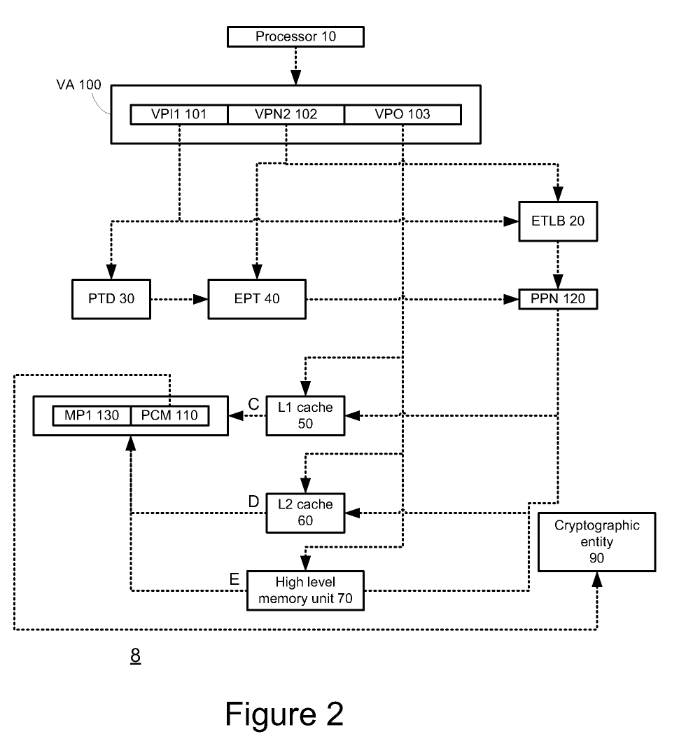

FIG. 2 illustrates the retrieval of PCM 110 and of the requested memory page (MP1 130) from another memory unit such as L1 cache 50, L2 cache 60 or high-level memory unit 70, according to an embodiment of the invention. These different memory units provide a hierarchical memory structure wherein a lower level memory miss, results in a retrieval attempt from a higher level memory unit. Thus, if MP1 130 and PCM 110 are stored in L1 cache 50 then PCM 110 is sent from L1 cache 50 to cryptography entity 90, as illustrated by letter C. If a L1 cache miss occurs then PCM 110 can be retrieved from L2 cache 60 (illustrated by letter D). If a L2 cache miss occurs then PCM 110 is retrieved from a high level memory unit 70 (illustrated by letter E).

Those of skill in the art will appreciate that system 8 can include more than three memory units, fewer memory units, and that the memory units can be located in proximity to each other, within the same computer, or can be connected to each other via a network, multiple links, and the like.

It is further noted cryptography entity 90 can be a software entity that is executed by processor 10.

Once PCM 110 is retrieved, cryptography entity 90 can perform one or more cryptographic operations such as encryption, decryption, compression, decompression, integrity check, and the like.

PCM 110 can include at least one of the following instructions: (i) perform write operation with encryption, (ii) perform write operation without encryption, (iii) perform read operation with encryption, (iv) perform read operation without encryption, (v) perform IO DMA read operation with encryption, (vi) perform IO DMA read operation without encryption, (vii) perform IO DMA write operation with encryption, (viii) perform IO DMA write operation without encryption, (ix) compress memory page before performing an encryption, (x) decompress memory page before performing an encryption, (xi) perform an integrity test, and the like.

Additionally or alternatively, PCM 110 can include an encryption key, a decryption key, encryption key location information (such as an encryption key pointer or an encryption key table pointer), decryption key location information (such as an decryption key pointer or an decryption key table pointer), compression algorithm location information (such as a compression algorithm pointer), enable/disable integrity digest indicator, integrity digest, compression algorithm, and the like.

According to an embodiment of the invention PCM 110 can merely point to another location that stored the metadata required for controlling and/or performing the cryptographic operation.

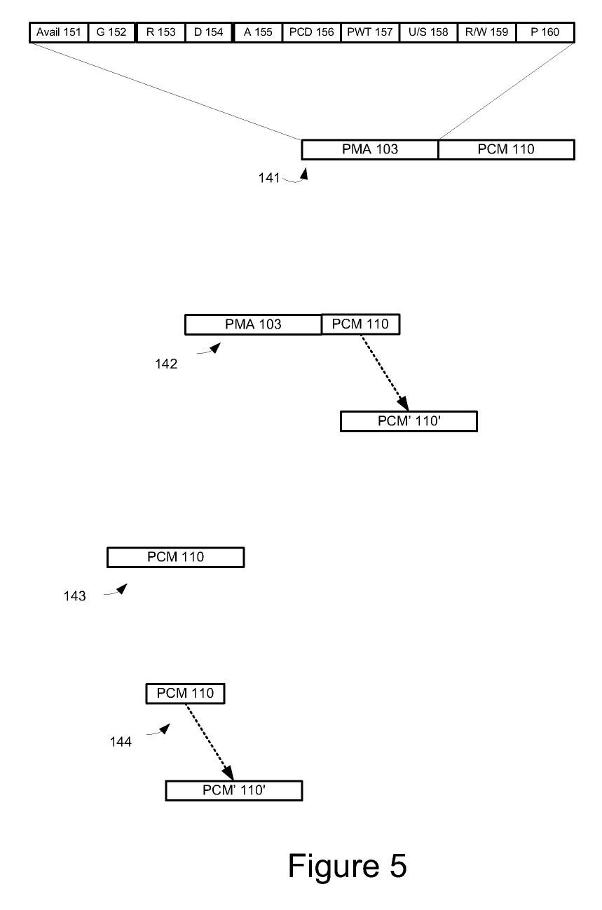

FIGS. 1 and 2 illustrate data structures such as EPT 40 and ETLB 20 that store both memory page cryptography metadata associated with first memory page address information. FIG. 5 illustrates various data structures that can be stored at an entry of EPT 40 or of ETLB 20 according to an embodiment of the invention.

Data structure 141 includes memory page memory access information (PMA) 103 and PCM 100. PMA 103 can include the following fields: “Avail” field 151 that is available for system programmer's use, “G” (global page) field 152, “R” (reserved field) 153, “D” (dirty field) 154, “A” (accessed field) 155, “PCD” (cache disabled field) 156, “PWT” (write-through field) 157, “U/S” (user or supervisor field) 158, “R/W” (read or write field) 159, and “P” (present field) 160. PMA 103 and its various fields are known in the art and do not require additional information.

Data structure 142 can also be stored within an entry of EPT 40 and ETLB 20. Data structure 142 includes PMA 103 and PCM 110 but PCM 110 includes a pointer to another location that stores yet additional memory page cryptography metadata PCM 110′.

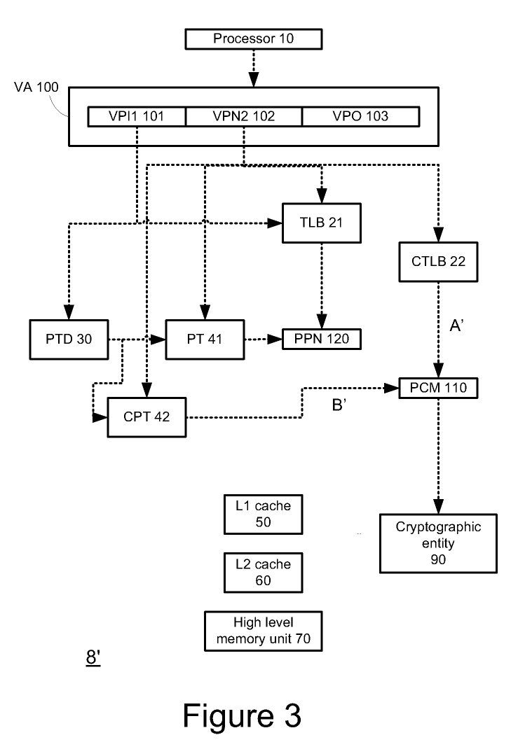

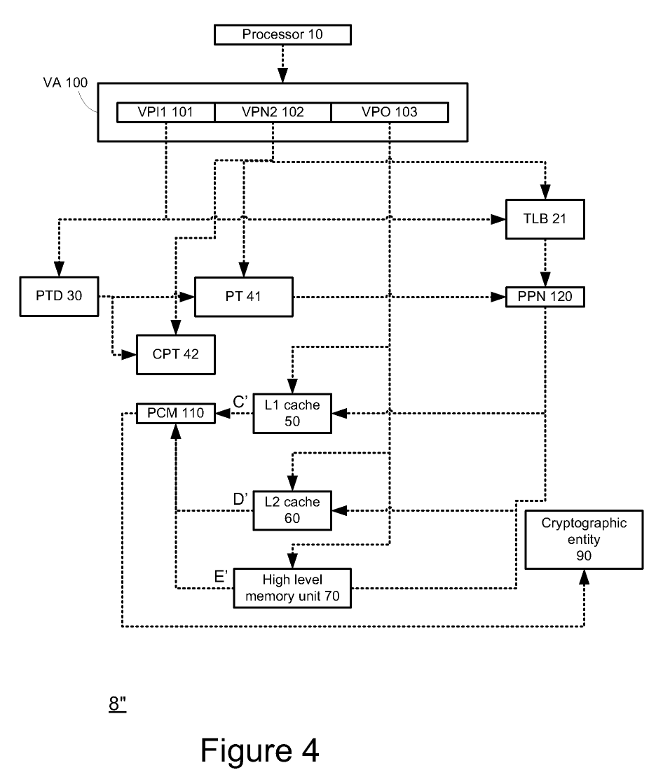

FIGS. 3 and 4 illustrate retrieval processes according to various embodiments of the invention.

The retrieval process illustrated in FIGS. 3 and 4 differ from those illustrated in FIGS. 1 and 2. FIGS. 1 and 2 illustrate ETLB 20 and EPT 40 that store memory page cryptography metadata and memory page address information. FIGS. 3 and 4 illustrate CTLB 22 and CPT 42 that store memory page cryptography metadata and TBL 21 and PT 41 that store memory page address information.

FIG. 3 illustrates a retrieval of memory page cryptography metadata (denoted PCM 110) from cryptographic page table (CPT) 42 and a retrieval of PCM 110 from cryptographic translation look-aside buffer (CTLB) 21, according to an embodiment of the invention. It is noted that the CPT 42 can be encrypted.

Processor 10 may request a memory page by providing VA 100 that includes multiple portions such as VPI1 101, VPN2 102 and VPO 103.

Portions of VA 100 are sent to one or more cryptographic metadata retrieval paths and to one or more corresponding memory page retrieval paths.

A first cryptographic metadata retrieval path includes CTLB 21. CTLB 21 stores memory page cryptography metadata. CTLB 21 is quite small and usually includes few entries. Each entry can store recently utilized memory page cryptography metadata. VPI1 101 and VPN2 102 are sent to CTLB 21 in order to retrieve the required memory page cryptographic metadata.

If a CTLB 21 hit occurs (the hit is illustrated by letter A′), then CTLB 21 sends PCM 110 to cryptographic entity 90.

If CTLB 21 does not store the required memory page cryptography metadata then this metadata can be retrieved from other cryptographic metadata retrieval paths.

FIG. 3 also illustrates a second cryptographic metadata retrieval path that includes PTD 30 and CPT 42.

VPI1 101 is sent to PTD 30 and is used to select a cryptographic page table such as CPT 42 out of multiple cryptographic page tables (not shown). It is noted that an cryptographic page table can be allocated per consumer or group (shared memory) and that the identity of the consumer or group can be represented by VPI1 101. It is further noted that for simplicity of explanation only a single CPT 42 is shown.

VPN2 102 is sent to CPT 42 and is used to select an entry of CPT 42. The selected entry can store PCM 110. Letter B′ illustrates the provision of PCM 110 from EPT 40.

FIG. 3 also illustrates two memory page retrieval paths. The first includes TLB 21 and the second includes PTD 30 and page table PT 41. VPI1 101 and VPN2 are sent to TLB 21 in order to retrieve the memory page address information. Page table 41 provides PPN 120 if PPN 120 is not stored in TLB 21.

It is noted that although FIGS. 3 and 4 illustrate a single page table directory, that separate page table directories can be used. For example, one page table directory will point to page tables such as PT 41, while another page table directory will point to cryptographic page tables such as CPT 42.

FIG. 4 illustrates the retrieval of PCM 110 from another memory unit such as L1 cache 50, L2 cache 60 or high-level memory unit 70, according to an embodiment of the invention. These different memory units provide a hierarchical memory structure wherein a lower level memory miss, results in a retrieval attempt from a higher level memory unit. Thus, if PCM 110 is stored in L1 cache 50 then PCM 110 is sent from L1 cache 50 to cryptography entity 90, as illustrated by letter C′. If a L1 cache miss occurs then PCM 110 can be retrieved from L2 cache 60 (illustrated by letter D′). If a L2 cache miss occurs then PCM 110 is retrieved from a high level memory unit 70 (illustrated by letter E′).

Those of skill in the art will appreciate that system 8′ can include more than three memory units, fewer memory units, and that the memory units can be located in proximity to each other, within the same computer, or can be connected to each other via a network, multiple links, and the like.

FIG. 5 illustrates various data structures that can be stored at an entry of CPT 42 or of CTLB 21 according to an embodiment of the invention.

Data structure 143 includes PCM 100. Data structure 144 can also be stored within an entry of CPT 42 and CTLB 21. Data structure 144 includes PCM 110 but PCM 110 includes a pointer to another location that stores yet additional memory page cryptography metadata PCM 110′.

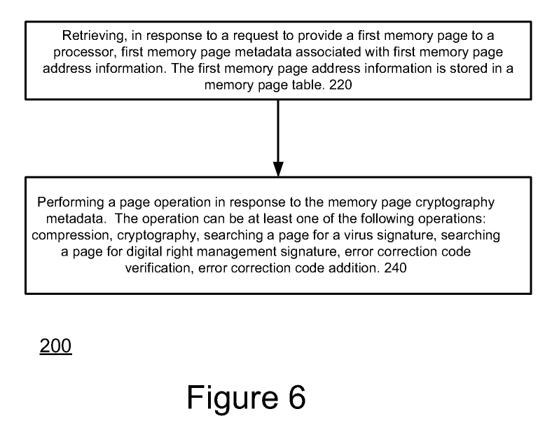

FIG. 6 illustrates method 200 for cryptographically processing a memory page, according to an embodiment of the invention.

Method 200 starts by stage 220 of retrieving, in response to a request to provide a first memory page to a processor, first memory page metadata associated with first memory page address information. This first memory page metadata can be first memory page cryptography metadata. The first memory page address information is fetched from a memory page table and may be stored in the ETLB or TLB, depending on the chosen implementation. Additionally, first memory page cryptography metadata may be stored in the ETLB or CTLB, again depending on the implementation. The memory page table can store memory page cryptographic metadata but this is not necessarily so. It is further noted that the first memory page address can be a virtual address, a physical address and the like.

The first memory page can be any memory page and the term “first” is just used to differentiate between the requested memory page to other memory pages.

Conveniently, stage 220 can include at least one of the following operations or (whenever possible) a combination thereof: (i) retrieving the first memory page cryptography metadata from the memory page table, (ii) retrieving the first memory page cryptography metadata from a cryptography memory page table, (iii) retrieving first memory page encryption metadata that comprises a pointer to a cryptographic element, (iv) retrieving first memory page encryption metadata that associates between a cryptographic operation and a memory page IO operation, (v) retrieving first memory page encryption metadata that associates between a cryptographic operation and a memory page compression operation, (vi) retrieving first memory page encryption metadata that comprises integrity test information.

Stage 220 is followed by stage 240 of performing a page operation in response to the memory page metadata. The page operation can be a page cryptography operation and the memory page metadata can be memory page cryptography metadata.

The page operation can include various above mentioned operations, such as but not limited to, encryption, decryption, compression and encryption, decryption and decompression, performing an integrity check, searching a page for a virus signature, searching a page for digital right management signature, error correction code verification, error correction code addition and the like.

It is noted that the memory page cryptography metadata can also include the state of the cryptography operations. It is noted that once a cryptography operation ends the state can be updated. It is noted that the state of the cryptography operation can indicate which portion of a memory page was already cryptographically processed.

The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

We claim:

1. A method for processing a memory page, the method comprises:
retrieving, in response to a request to provide a first memory page to a processor, first memory page metadata associated with first memory page address information; wherein the first memory page address information is stored in a memory page table; and
performing a page operation in response to the memory page metadata; wherein the page operation is selected from a group consisting of compression, cryptography, searching a page for a virus signature, searching a page for digital right management signature, error correction code verification, error correction code addition.

2. The method according to claim 1 wherein the retrieving comprises retrieving first memory page cryptography metadata from the memory page table.

3. The method according to claim 1 wherein the retrieving comprises retrieving first memory page cryptography metadata from a cryptography memory page table.

4. The method according to claim 1 wherein the retrieving comprises retrieving first memory page encryption metadata that comprises a pointer to a cryptographic element.

5. The method according to claim 1 wherein the retrieving comprises retrieving first memory page encryption metadata that associates between a cryptographic operation and a memory page IO operation.

6. The method according to claim 1 wherein the retrieving comprises retrieving first memory page encryption metadata that associates between a cryptographic operation and a memory page compression operation.

7. The method according to claim 1 wherein the retrieving comprises retrieving first memory page encryption metadata that comprises integrity test information.

8. A computer program product comprising a computer usable medium including a computer readable program, wherein the computer readable program when executed on a computer causes the computer to:
retrieve, in response to a request to provide a first memory page to a processor, first memory page metadata associated with first memory page address information;
wherein the first memory page address information is stored in a memory page table; and
perform a page operation in response to the memory page metadata; wherein the page operation is selected from a group consisting of compression, cryptography, searching a page for a virus signature, searching a page for digital right management signature, error correction code verification, error correction code addition.

9. The computer program product according to claim 8, wherein the computer readable program when executed on a computer causes the computer to retrieve first memory page cryptography metadata from the memory page table.

10. The computer program product according to claim 8, wherein the computer readable program when executed on a computer causes the computer to retrieve first memory page cryptography metadata from a cryptography memory page table.

11. The computer program product according to claim 8, wherein the computer readable program when executed on a computer causes the computer to retrieve first memory page metadata that comprises a pointer to a cryptographic element.

12. The computer program product according to claim 8, wherein the computer readable program when executed on a computer causes the computer to retrieve first memory page metadata that associates between a cryptographic operation and a first memory page IO operation.

13. The computer program product according to claim 8, wherein the computer readable program when executed on a computer causes the computer to retrieve first memory page metadata that associates between a cryptographic operation and a first memory page compression operation.

14. The computer program product according to claim 8, wherein the computer readable program when executed on a computer causes the computer to retrieve first memory page metadata that comprises integrity test information.

15. A system for cryptographically processing a first memory page, the system comprises:
a memory unit adapted to store first memory page metadata associated with first memory page address information of a first memory page, wherein the first memory page address information is stored in a memory page table; and
a processing entity, adapted to perform a page operation in response to the memory page metadata; wherein the page operation is selected from a group consisting of compression, cryptography, searching a page for a virus signature, searching a page for digital right management signature, error correction code verification, error correction code addition.

16. The system according to claim 15 wherein the processing entity is adapted to retrieve first memory page cryptography metadata from the memory page table.

17. The system according to claim 15 wherein the processing entity is adapted to retrieve first memory page cryptography metadata from a cryptography memory page table.

18. The system according to claim 15 wherein the processing entity is adapted to retrieve a cryptographic element pointed to by the first memory page metadata.

19. The system according to claim 15 wherein the processing entity is adapted to retrieve first memory page metadata that associates between a cryptographic operation and a first memory page IO operation.

20. The system according to claim 15 wherein the processing entity is adapted to retrieve first memory page metadata that associates between a cryptographic operation and a first memory page compression operation.
